(19) United States
(12) Patent Application Publication
(10) Pub. No.: US 2007/0043859 A1
(43) Pub. Date: Feb. 22, 2007

(54) Systems and methods for content monitoring on a network

(76) Inventor: George Eino Ruul, Applecross (AU)

Correspondence Address: CARR & FERRELL LLP, 2200 GENG ROAD, PALO ALTO, CA, 94303, US

(21) Appl. No.: 11/481,564

(22) Filed: Jul. 5, 2006

Related U.S. Application Data
(63) Continuation-in-part of application No. 11/258,419, filed on Oct. 24, 2005.
(60) Provisional application No. 60/696,997, filed on Jul. 5, 2005.

(51) Int. Cl. G06F 15/173

(52) U.S. Cl. 709/224

(57) ABSTRACT

Exemplary systems and methods for content monitoring are provided. An exemplary content monitor comprises a plug-in application configured to initiate the monitoring of a network for one or more parameters over an extended time period. A mechanism is provided for notifying users about content monitoring results immediately after the one or more parameters are found on the network. Exemplary methods of the content monitor include a method for content monitoring comprising the entering of one or more parameters and monitoring the network for the one or more parameters over an extended time period.

### CROSS REFERENCE TO RELATED APPLICATIONS

The present application is a continuation-in-part application of U.S. patent application Ser. No. 11/258,419 filed Oct. 24, 2005 and entitled “Content Monitor;” and claims the benefit and priority of Provisional Patent Application Ser. No. 60/696,997, filed Jul. 5, 2005 and entitled “System and Method for Optimized E-Commerce Trading,” both application being incorporated herein by reference.

### BACKGROUND OF THE INVENTION

1. Field of the Invention

The present invention relates generally to searches, and more particularly to content monitors for online searching.

2. Description of Related Art

The Internet has developed into a dominant force in the global business market. Businesses may now sell products, deal with vendors, and promote items via the Internet. On the consumer-side, a prospective buyer may visit multiple websites in order to determine the best price for a particular product—a very time consuming process. Alternatively, the buyer may depend on a shopping comparison site to search out the best price. These shopping comparison sites, however, typically only provide dated information obtained from, or “pushed” by, seller websites. Thus, if a seller does not have a website, has not updated their website recently, or has not “pushed” a recent copy of their inventory to a comparison site central database, the information obtained by the consumer may not be the best information available.

In addition to the challenges associated with the content that is already on the Internet, finding content uploaded to the Internet subsequent to a search can also be challenging. The process of locating new content is an active process with a user's chances of finding the desired content linked to the time spent searching the Internet. Short of performing another time-consuming manual search, users have no way of knowing whether newer and more relevant content has been subsequently uploaded to the Internet. Likewise, should Internet content providers learn of the content Internet users seek and subsequently provide such content, Internet content providers have no way of knowing that the same users will learn about the new content. Accordingly, there is a need for content monitoring.

### SUMMARY

The present invention provides exemplary systems and methods for content monitoring. An exemplary content monitor comprises a plug-in application configured to initiate the monitoring of a network for one or more parameters. A mechanism is provided for notifying users about content monitoring results after the one or more parameters are found on the network. Other embodiments of the system include a server and/or an e-community module configured with the plug-in application.

Exemplary methods of content monitoring include receiving one or more parameters, copying the one or more parameters and/or circulating or recirculating the one or more parameters through a network. Exemplary methods also include notifying a user about monitoring results after the one or more parameters are found on the network.

### BRIEF DESCRIPTION OF THE DRAWINGS

FIG. 1 is an exemplary e-community architecture for providing a content monitor;

FIG. 2 is an exemplary e-community server according to one embodiment;

FIG. 3 shows an exemplary scenario of a direct search by an e-community member;

FIG. 4 shows an exemplary scenario of an indirect search by an e-community member; and

FIG. 5 is a flowchart of an exemplary method of content monitoring, according to some embodiments.

### DESCRIPTION OF EXEMPLARY EMBODIMENTS

Exemplary embodiments of the present invention provide a content monitor configured to monitor information located at a plurality of computing devices in a real-time networked environment. In contrast to prior art methods of polling relevant sources of information on a regular basis to determine information changes, embodiments of the present invention notifies the relevant sources that a particular piece of information is desired via search parameters. The relevant sources then notify a user when the search parameters are met. This eliminates the need for constant or timed polling.

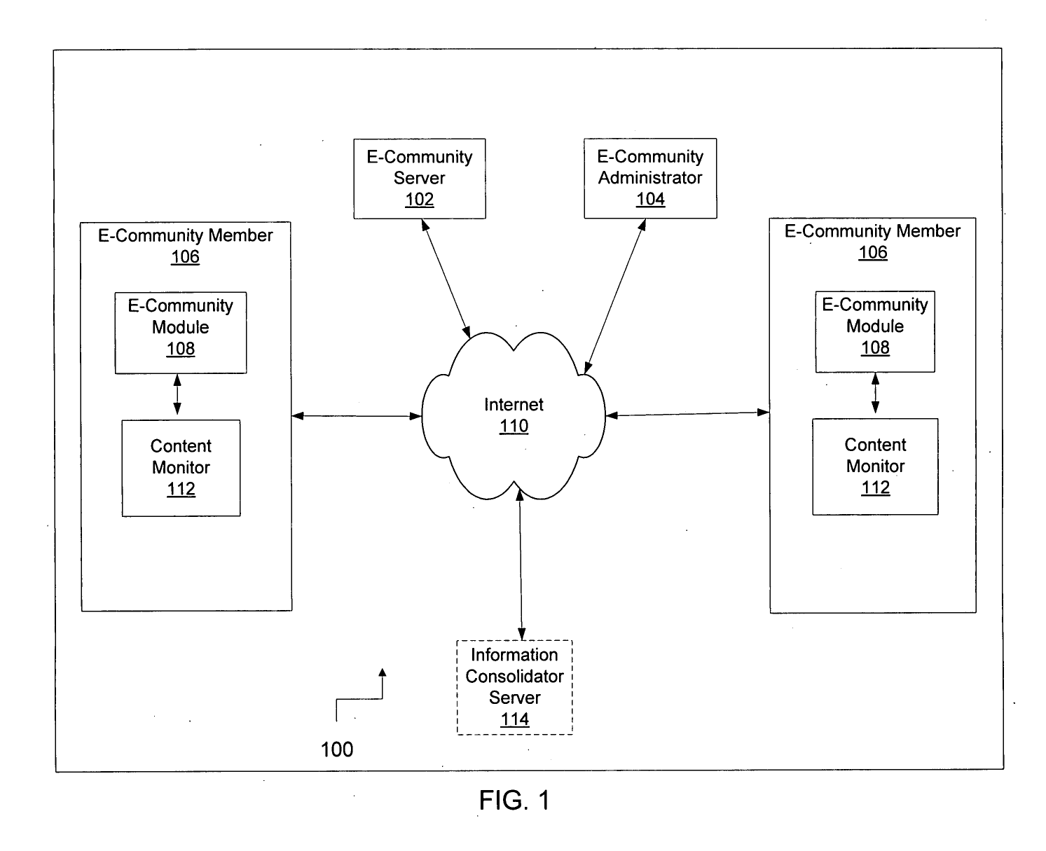

Referring to FIG. 1, an exemplary e-community architecture 100 for utilizing a content monitor is shown. The architecture 100 comprises various e-community components, including an e-community server 102, an e-community administrator 104, and one or more e-community members 106. The e-community member 106 may be a user on a computer, a mobile phone (i.e., a thin client device), or any other wired or wireless computing device that allows for searching on a network.

According to some exemplary embodiments, the computing devices used by e-community members 106 comprise an e-community module 108 operating over a network. In exemplary embodiments, the e-community module 108 is downloaded from the e-community server 102. The exemplary e-community module 108 may further comprise a content monitor 112 in the form of a plug-in application. In alternative embodiments, the content monitor 112 may be downloaded as part of the e-community module 108. An optional information consolidator server 114 may also comprise the exemplary e-community architecture 100.

E-community module 108 and content monitor 112 integrate into the computing devices of e-community members 106. The exemplary e-community module 108 may comprise a specialized browser technology optimized for e-community communication using the Internet 110 without depending on existing HTML/XML browser technology. In further embodiments, the e-community module 108 allows e-community members 106 to set-up favorite groups of e-communities that the member 106 can interact with (e.g., perform searches).

The e-community module 108 also allows an e-community member 106 to customize search options and perform customization features. For example, customization by the e-community member 106 may include using the e-community module 108 to program or configure the content monitor 112 to become activated upon receiving one or more unfulfilled search parameters in connection with a search request or to be activated at all times. An unfulfilled search request may be a search or query wherein one or more search parameters are not found on a network. In an e-commerce example, price, quantity, and product description represent three parameters for which the e-community member 106 may elect to activate the content monitor 112. Parameters can also include product codes (whole, part, or sectional), product descriptions, part numbers, keywords, or any other flexible search criteria.

According to exemplary embodiments, if a searching e-community member 106 fails to locate one or more parameters associated with a particular search or query, the content monitor 112 is activated. As default parameters, the content monitor 112 will use the parameters used during the search that are returned unfulfilled after the search. Alternatively, the e-community member 106 can enter or program other parameters to be used by the content monitor 112. In further embodiments, the content monitor 112 can be programmed or configured to prioritize the relative value assigned to the parameters to be monitored. For example, an e-community member 106 can assign a higher priority to monitoring for a particular product than to monitoring for the particular product at a particular price or range of prices. In yet further embodiments, an e-community member 106 can select from a historical listing or menu of parameters previously monitored by the content monitor 112.

In other embodiments, the e-community member 106 may activate the content monitor 112 at any time. That is the content monitor 112 may receive search parameters prior to any failed attempt at a search.

The content monitor 112 can be used to monitor a network for any situation. In exemplary embodiments, the content monitor 112 can be programmed or configured to monitor for parameters pertaining to events, news, information, or other network occurrences. For example, the content monitor 112 can be programmed to monitor a network for information concerning the Dow Jones Industrial Average exceeding 15,000. In yet further embodiments, parameters monitored by the content monitor 112 are published within an e-community.

The content monitor 112 can be programmed or configured with notification preferences specifying how the e-community member 106 should be contacted when certain parameters are found on a network by the content monitor 112. Based on the notification preferences entered by the e-community member 106, should one or more of the corresponding parameters be found by the content monitor 112, a message in the form of an email, instant message or similar form can be generated and transmitted to the e-community member 106.

It should be noted that architecture 100 in FIG. 1 is exemplary. Alternative embodiments may comprise more or fewer components. For example, more than one information consolidator server 114 or e-community server 102 may be provided. Furthermore, any number of e-community members 106 may be present on the system. Furthermore, while FIG. 1 shows the components communicating over the Internet 110, any type of network may be utilized, such as a wide area network, a peer-to-peer network, a peer-to-anything network (e.g., person to a website), etc.

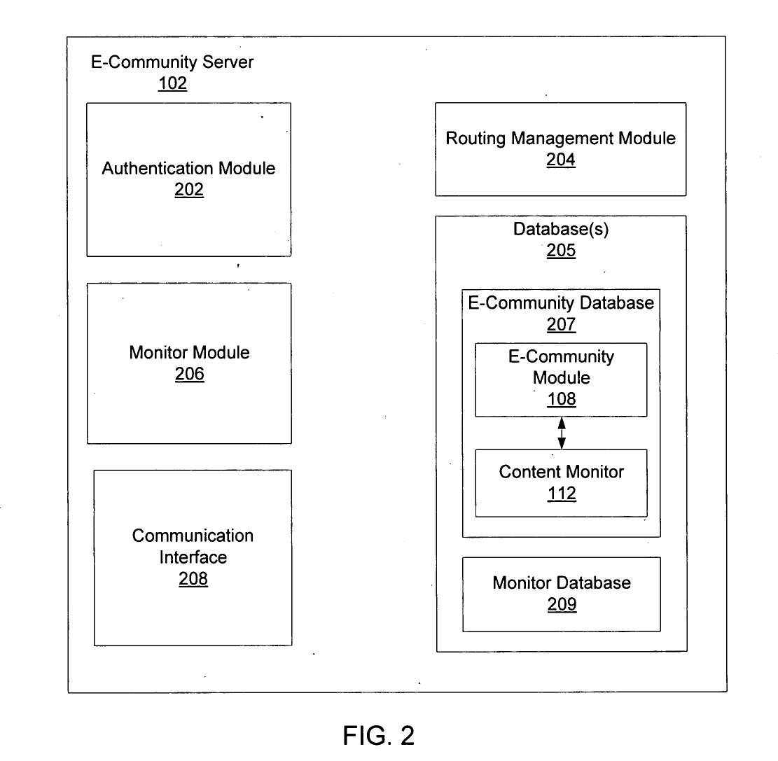

Referring to FIG. 2, an exemplary e-community server 102 (FIG. 1) is shown in more detail. In exemplary embodiments, the e-community server 102 comprises an authentication module 202, a routing management module 204, at least one database 205, a monitor module 206, and a communication interface 208. In further embodiments, the database 205 comprises a plurality of databases, each storing designated data. For example, the database 205 may comprise an e-community database 207 and a monitor database 209. In yet a further embodiment, the e-community server 102 is coupled to at least one database 205 which is located outside of the e-community server 102.

The e-community database 207 stores various e-community and e-commerce modules and plug-in applications that can be accessed and downloaded onto the computerized devices of e-community members 106 (FIG. 1). These modules and plug-in applications include the e-community module 108 (FIG. 1) and the content monitor 112 (FIG. 1).

In exemplary embodiments, copies of the entered or programmed parameters contained in the content monitor 112 are made by the e-community module 108 at the e-community member 106. The copies are then sent to the e-community server 102, and stored, for example, in the monitor database 209. Then, at a predetermined time or when a predetermined number of copies are stored, the copies are retrieved by the e-community server 102 and/or the e-community administrator 104 (FIG. 1).

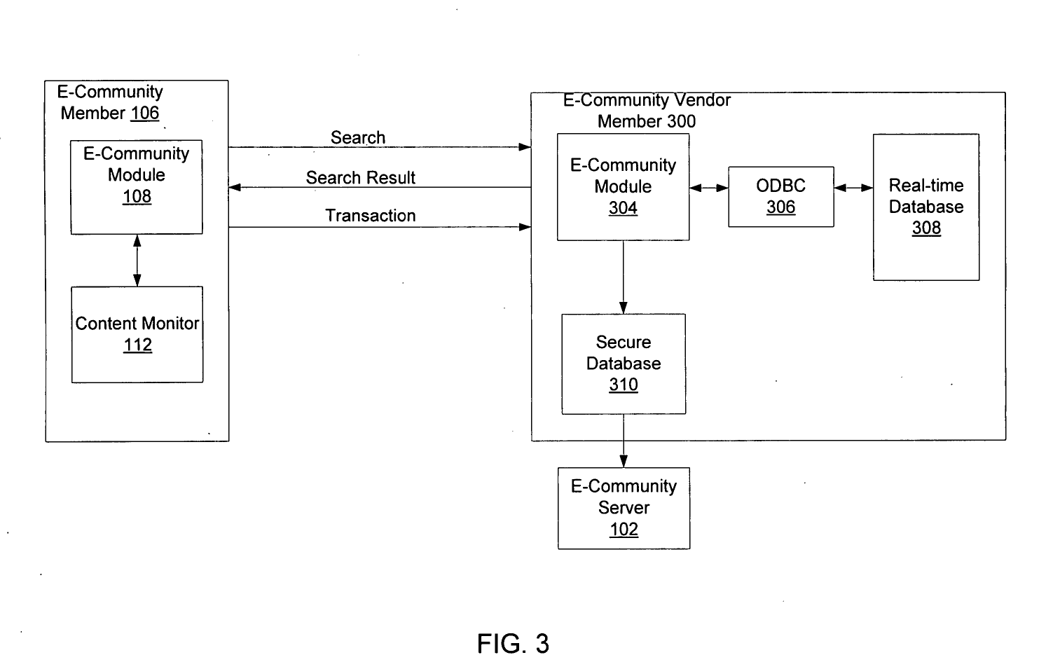

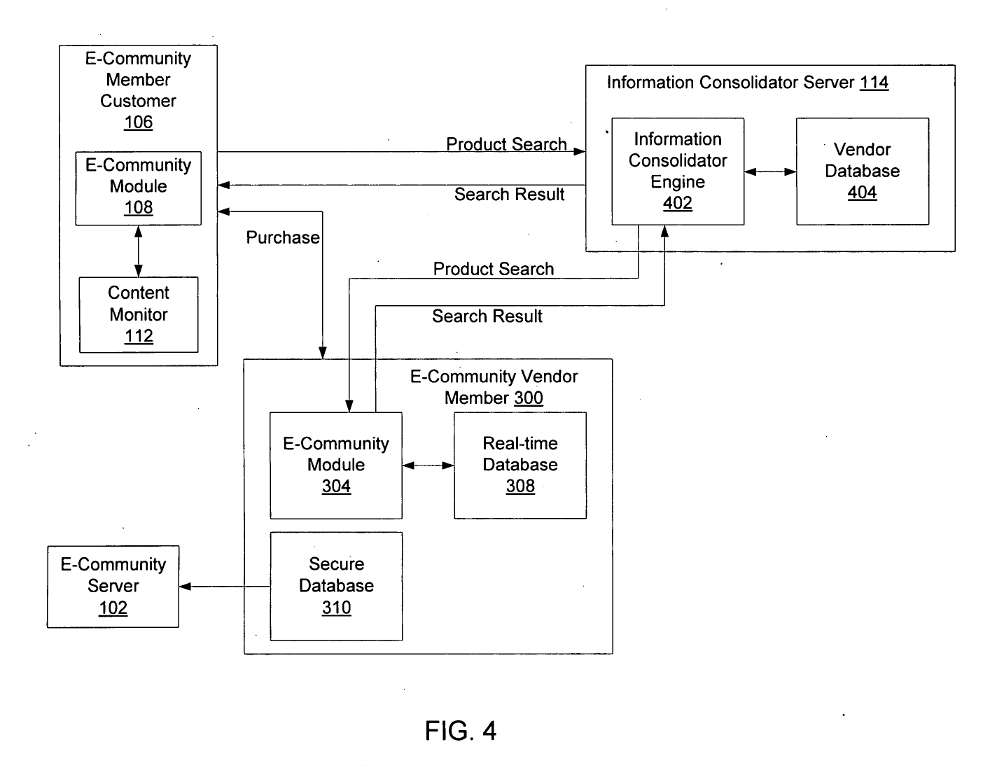

The content monitor 112 functions in an integrated and coordinated fashion with most network search mechanisms. Accordingly, the functioning of the content monitor 112 can be further described in connection with the descriptions of two exemplary network search scenarios shown in FIGS. 3-4.

Referring to FIG. 3, an exemplary scenario of a direct search by an e-community member 106 (FIG. 1) is shown. In the particular search shown in FIG. 3, the e-community member 106 represents the example of a wine collector in search of a vintage bottle of merlot. In further embodiments, the search may be conduct on any item, information, or event.

In the exemplary scenario shown in FIG. 3, the vintage bottle of merlot sought by the e-community member 106 is owned by an e-community vendor member 300 of an e-community dedicated to wine collecting. The e-community vendor member 300 may be an individual e-community member 106, a business, or any other entity having an affiliation with the wine collecting e-community. The e-community vendor member 300 has a corresponding e-community (vendor) module 304. In this scenario, when the e-community vendor member 300 registered with the e-community server 102 (FIG. 1), the e-community (vendor) module 304 was downloaded and installed from the e-community server 102 onto the corresponding computing device of e-community vendor member 300. The e-community (vendor) module 304 in some embodiments may comprise a content monitor (not shown) and have the same e-community module functionalities as e-community module 108 (FIG. 1). In the scenario shown in FIG. 3, the e-community vendor member 300 further comprises an inventory database 308 containing a listing of every bottle of wine available for sale or trading.

According to exemplary embodiments, searches are forwarded from the e-community members 106 to available e-community vendor members 300. In the embodiment shown in FIG. 3, the e-community member 106 performing the search has direct access to and communicates with the e-community vendor member 300. Thus, the search is sent directly from the e-community module 108 of the e-community member 106 to the e-community (vendor) module 304 of the e-community vendor member 300.

Upon the e-community (vendor) module 304 receiving the search request, the search request is passed to the real-time database 308 of the e-community vendor member 300. In one embodiment, the search request is passed via an open database connection (ODBC) 306, although other mechanisms may be used. According to some embodiments, the inventory database 308 is accessible via the native programming of the inventory database 308 instead of or in addition to the open database connection (ODBC) 306. The real-time database 308 may comprise an inventory database in some embodiments. The real-time database 308 is searched for the vintage bottle of merlot. After the real-time database 308 is searched, the resulting information is sent back via the e-community (vendor) module 304 to the e-community module 108 of the e-community member 106 performing the search. If the e-community member 106 decides to make an offer to the e-community vendor member 300 for the vintage bottle of merlot, a purchase/trade request communication is sent by the e-community member 106 performing the search to the e-community vendor member 300.

According to exemplary embodiments, if the e-community member 106 fails to locate one or more parameters associated with a particular search or query, the content monitor 112 (FIG. 1) is activated. The content monitor 112 will use the same parameters that were used during the search that were returned unfulfilled after the search. Alternatively, the e-community member 106 can enter other parameters and/or modify the parameters used in connection with the search.

The parameters entered or programmed into the content monitor 112 may be stored in the e-community server 102 or with the e-community administrator 104 (FIG. 1) according to exemplary embodiments. In the case of the direct search described in connection with FIG. 3, according to some embodiments, the e-community server 102 and/or the e-community administrator 104 may periodically transmit a copy of the parameters to the e-community (vendor) module 304. The e-community (vendor) module 304 can then compare the parameters to data in the real-time database 308 of the e-community vendor member 300. This process may continue at intervals and for a duration programmed by the e-community member 106 or until one or more of the corresponding parameters are found by the content monitor 112.

In another embodiment of the present invention, the parameter may be embedded into a database (e.g., secure database 310 or real-time database 308) that is coupled to the e-community (vendor) module 304. In some embodiments, the e-community (vendor) module 304 comprises, or is associated with, a vendor version of the content monitor 112. The content monitor 112 at the vendor is configured to interact with the real-time database 308 to detect changes that incur in the real-time database 308. If a change detected causes one or more of the parameters to match, then the component is triggered to respond to the e-community member 106. Thus, the vendor version of the content monitor 112 is configured to query the coupled real-time inventory to search for matches to the parameters.

Based on the notification preferences programmed by the e-community member 106, should one or more of the corresponding parameters be found in the real-time database 308 of the e-community vendor member 300, a message in the form of an email, instant message or similar form may be generated and transmitted to the e-community member 106.

While the example of FIG. 3 shows one e-community member 106 directly searching the e-community vendor member 300, embodiments of the present invention allow one or more e-community members 106 to directly search one or more e-community vendor members 300 at a substantially simultaneous time. Additionally, while a product search of an e-community vendor member 300 is described, embodiments of the present invention may be practiced with a non-product search between some or all members of the e-community.

Referring to FIG. 4, an exemplary scenario of an indirect product search between the e-community member 106 (FIG. 1) and the e-community vendor member 300 (FIG. 3) is shown. In the indirect search scenario, queries and responses are directed through the information consolidator server 114 (FIG. 1). According to some embodiments, the information consolidator server 114 further comprises an information consolidator engine 402 and a vendor database 404.

Upon receiving the product search, the information consolidator engine 402 checks the vendor database 404 coupled to the information consolidator engine 402 to determine qualified e-community vendor members 300 to which the information consolidator engine 402 can forward the query. Although only one e-community vendor member database 404 is shown, alternative embodiments may comprise any number of e-community vendor databases 404.

Once the one or more proper e-community vendor members 300 are identified, the product search is forwarded to each e-community vendor member 300. In exemplary embodiments, the e-community vendor member 300 has downloaded and installed the e-community module 304 (FIG. 3) to its network coupled computing device. A business profile of the e-community vendor member 300 including information such as the name and address of the e-community vendor member 300 may be stored in the e-community vendor member database 404 and used to determine search query access (i.e., where a product search query should be sent).

The product search query is forwarded to the e-community module 304 at the e-community member vendor 300 site. The e-community module 304 checks a real-time database 308, which is coupled to the e-community module 304, to determine information based on the product search.

The search result is then sent to the e-community member 106 via the information consolidator server 114. Should the e-community member 106 decide to purchase the product, the e-community member 106, in one embodiment, establishes a link with the e-community vendor member 300 and proceeds with purchase of the product(s) directly from the e-community vendor member 300.

As described in connection with FIG. 3, if the e-community member 106 performing the search fails to locate one or more parameters associated with a particular search or query, the content monitor 112 is activated. The parameters entered or programmed into the content monitor 112 are stored in the e-community server 102, stored in the information consolidator server 114, or stored by the e-community administrator 104 according to exemplary embodiments.

In some embodiments, the information consolidator server 114 receives information from the e-community vendor members 300. That is the e-community vendor members 300 may push data, such as news, events, product listings, and pricing, to the information consolidator. Alternatively, the information consolidator 114 pings the e-community vendor members 300 for updates periodically. In these embodiments, the information consolidator server 114 may be a massive data storage device. The data may then be stored at the information consolidator server. In the embodiment where the parameters are stored at the information consolidator server 114, as soon as content that matches the parameters arrives at the information consolidator server 114, the e-community member 106 is alerted.

In the case of the exemplary indirect product search described in connection with FIG. 4, according to some embodiments, the e-community server 102 and/or the e-community administrator 104 may periodically transmit a copy of the parameters to the information consolidator engine 402. The information consolidator engine 402 checks the e-community vendor member database 404 to determine the qualified e-community vendor members 300 to forward the parameters. Once the one or more proper e-community vendor members 300 are identified, the parameters are forwarded to each of the e-community vendor members 300. The parameters are then forwarded to the e-community module 304. The e-community module 304 checks a coupled inventory database 308. This process can continue at the intervals and for a duration programmed by the e-community member 106 or until one or more of the corresponding parameters are found by the content monitor 112 on the network.

Based on the notification preferences programmed by the searching e-community member 106, should one or more of the corresponding parameters be found in the inventory database 308 of the e-community vendor member 300, a message in the form of an email, instant message or similar form may be generated and transmitted to the e-community member 106.

While the example of FIG. 4 shows the e-community member 106 directly searching the e-community vendor member 300, embodiments of the present invention allow one or more e-community members 106 to directly search one or more e-community member vendors 300 at a substantially simultaneous time.

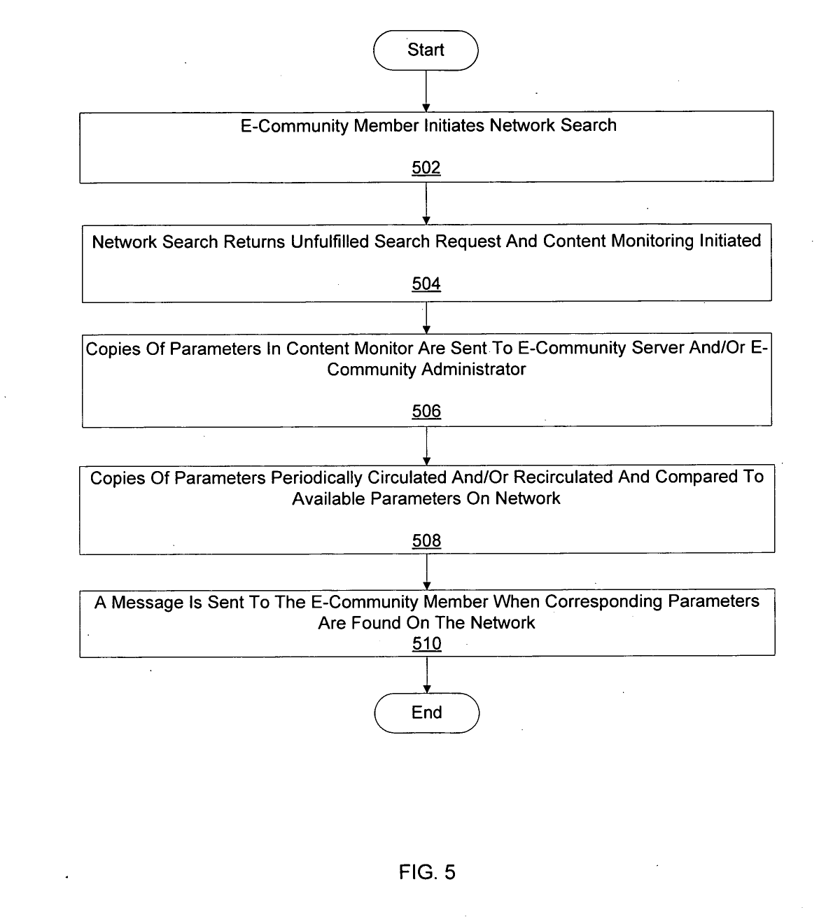

Referring to FIG. 5, an exemplary method of content monitoring according to some embodiments is shown. At step 502, an e-community member 106 (FIG. 1) initiates a network search for one or more parameters. In some embodiments, the parameters may comprise a particular product, event, news, or any other information found on the network. During the network search, search parameters are compared to available parameters on the network, as described in connection with FIGS. 3-4 herein.

In step 504, the network search returns an unfulfilled search request and content monitoring may be initiated. An unfulfilled search request may be a search or query wherein one or more search parameters are not found on a network. In some embodiments, the e-community module 108 (FIG. 1) allows an e-community member 106 to program or configure the content monitor 112 (FIG. 1) to become activated upon receiving one or more unfulfilled search parameters in connection with a search request. In further embodiments, the one or more unfulfilled search parameters are used as default parameters by the content monitor 112. Parameters may comprise names, prices, products, news titles, event titles, or any other flexible search criteria or keyword. Alternatively, the e-community member 106 can enter or program other parameters to be used by the content monitor 112.

In alternative embodiments, the content monitor 112 maybe activated prior to an unfulfilled search request. For example, the e-community member 106 may activate the content monitor 112 and provide search parameters. The content monitor 112 then initiates the search.

At step 506, according to exemplary embodiments, copies of the entered or programmed parameters contained in the content monitor 112 are made by the e-community module 108. The copies are then sent to the e-community server 102 (FIG. 1) and/or the information consolidator server 114. For example, copies may be stored in the monitor database 209 (FIG. 2). Then, at a predetermined time or when a predetermined number of copies are stored, the copies are accessed by the e-community server 102 and/or the e-community administrator 104 (FIG. 1). Alternatively, at predetermined times, the e-community server 102 or e-community administrator 104 can retrieve the information from the monitor database 209.

At step 508, copies of the parameters are periodically circulated and/or recirculated and compared to the available parameters on the network. According to some embodiments, the e-community server 102 and/or the e-community administrator 104 may periodically transmit a copy of the parameters to the e-community (vendor) module 304 (FIG. 3). The e-community (vendor) module 304 can then compare the parameters versus the real-time database 308 (FIG. 3) of the e-community vendor member 300 (FIG. 3). The comparison may be performed by a content monitor associated with the e-community (vendor) module 304. This process may continue at intervals and for a duration programmed by the e-community member 106 or until one or more of the corresponding parameters are found by the content monitor 112.

According to yet other embodiments, the e-community server 102 and/or the e-community administrator 104 may periodically transmit a copy of the parameters to the information consolidator engine 402 (FIG. 4) and/or the parameters may be stored at the information consolidator server 116. In one embodiment, the information consolidator engine 402 checks the e-community vendor member database 404 (FIG. 4) to determine the qualified e-community vendors 300 to forward the parameters. Once the one or more proper e-community vendor members 300 are identified, the parameters are forwarded to each of the e-community vendor members 300. At each e-community vendor member 300, the parameters are forwarded to the e-community module 304. The e-community module 304 (e.g., a content monitor 112 of the e-community module 304) checks a coupled inventory database 308. This process can continue at the intervals and for a duration programmed by the e-community member 106 or until one or more of the corresponding parameters are found by a content monitor 112 on the network.

In an alternative embodiment, the information consolidator server 114 receives information from the e-community vendor members 300. That is the e-community vendor members 300 may push data, such as news, events, product listings, and pricing, to the information consolidator. In these embodiments, the information consolidator server 114 may be a massive data storage device. The data may then be stored at the information consolidator server 114. In the embodiment where the parameters are stored at the information consolidator server 114, as soon as content that matches the parameters arrives at the information consolidator server 114, the e-community member 106 is alerted.

At step 510, when corresponding parameters on the network are found, a message is sent to the e-community member 106. The content monitor 112 can be programmed or configured with notification preferences specifying how the e-community member 106 should be contacted when certain parameters are found on the network. Based on the notification preferences entered by the e-community member 106, should one or more of the corresponding parameters be found, a message in the form of an email, instant message or similar form can be generated and transmitted to the e-community member 106.

While the present description provides examples of content monitoring in terms of a product search, embodiments of the present invention may monitor and find any type of information. For example, the e-community vendor member may comprise any data source (e.g., news agency). Additionally, while embodiments refer to a real-time database 308, any type of database may be accessed to find matches to the parameters. Further, while embodiments have been described with reference to an e-community, embodiments of the present invention may apply to any network of users and is not limited to e-communities.

The present invention is described above with reference to exemplary embodiments. It will be apparent to those skilled in the art that various modifications may be made and other embodiments can be used without departing from the broader scope of the present invention. Therefore, these and other variations upon the exemplary embodiments are intended to be covered by the present invention.

What is claimed is:

1. A content monitor comprising:
a plug-in application configured to initiate content monitoring of a network for one or more parameters over an extended time period; and
a mechanism for notifying a user about results of content monitoring after the one or more parameters are found on the network.

2. The system of claim 1 wherein the parameters comprise a particular product.

3. The system of claim 1 wherein the network is monitored until a predetermined expiry date.

4. The system of claim 3 wherein the network is monitored at a predetermined interval until the predetermined expiry date.

5. The system of claim 1 wherein the notification mechanism comprises an email.

6. The system of claim 1 wherein the notification mechanism comprises an instant message.

7. The system of claim 1 wherein the one or more parameters are published within an e-community.

8. The system of claim 1 further comprising an e-community module configured with the plug-in application.

9. A method for content monitoring comprising:
receiving one or more parameters;
monitoring a network for the one or more parameters; and
notifying a user about monitoring results after the one or more monitoring parameters are found on the network.

10. The method of claim 9 wherein monitoring the network comprises storing the parameters at an information consolidator server, the information consolidator server comparing the parameters with data received from other users at the information consolidator server.

11. The method of claim 10 monitoring the network comprises storing the parameters at a database coupled to a user e-community module, the user e-community module querying a coupled real-time database for a match to the parameters.

12. The method of claim 9 wherein the one or more parameters comprise a particular product.

13. The method of claim 9 further comprising publishing the one or more parameters within an e-community.

14. A server comprising:
a plug-in application configured to initiate content monitoring of a network for one or more parameters; and
a mechanism for notifying a user about results of content monitoring after the one or more parameters are found on the network.

15. The system of claim 14 further comprising an e-community module configured with the plug-in application.

16. The system of claim 14 wherein the parameters comprise a particular product.

17. The system of claim 14 wherein the network is monitored until a predetermined expiry date.

18. The system of claim 17 wherein the network is monitored at a predetermined interval until the predetermined expiry date.

19. The system of claim 14 wherein the one or more parameters are published within an e-community.
